(19) United States
(12) Patent Application Publication
(10) Pub. No.: US 2020/0146331 A1
(43) Pub. Date: May 14, 2020

(54) KITCHEN COUNTERTOP FOOD BAR MAKER

(71) Applicant: Daniel McClory, Middleton, MA (US)

(72) Inventor: Daniel McClory, Middleton, MA (US)

(21) Appl. No.: 16/684,511

(22) Filed: Nov. 14, 2019

Related U.S. Application Data
(60) Provisional application No. 62/766,992, filed on Nov. 14, 2018.

(51) Int. Cl. A23P 10/28; A47J 43/20; A23P 30/10

(52) U.S. Cl. CPC A23P 10/28; A23P 30/10; A47J 43/20

(57) ABSTRACT

A kitchen countertop appliance for making compressed food bars at home out of a user's selected ingredients. The kitchen countertop food bar maker uses a press to compress ingredients in a mold. The press can be operated manually or electronically, and can utilize any suitable press machinery, such as a worm drive, a servo press, or a linear actuator. The mold can come in a variety of shapes and sizes, and the press plate can be embossed with a logo so that it stamps the logo into the top of the food bar when pressed. The mold and press plate are removable for cleaning and swapping out different shaped or sized molds.

### CROSS-REFERENCE TO RELATED APPLICATION

The present application is related to and claims priority from prior provisional application Ser. No. 62/766,992, filed Nov. 14, 2018, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of kitchen countertop appliances. More specifically, the invention is a kitchen countertop food bar maker that compresses various ingredients into a compact, portable food bar.

### 2. DESCRIPTION OF THE RELATED ART

There are a large number of kitchen countertop appliances on the market, ranging from toaster ovens to espresso makers to juicers. Some juicers use a press, however the juicer presses are designed to crush various fruit and vegetables to release the juice, and then separate the juice from the remaining crushed material.

Various granola bars are presumed to be made on industrial presses. Such presses are generally large and often designed to be part of a conveyor belt system in order to meet the demands of the industry. Consequently, industrial presses are not adaptable for home use. Bars of food can be shaped by hand, but it is difficult to achieve the level of compression necessary to make everything stick together without resorting to weights or other methods of compression that may not produces homogeneous results.

Ideally, a kitchen countertop food bar maker should provide a safe, hygienic, and easy way to compress ingredients into a food bar and, yet would operate reliably and be manufactured at a modest expense. Thus, a need exists for a reliable kitchen countertop food bar maker to avoid the above-mentioned problems.

### BRIEF SUMMARY OF THE INVENTION

In view of the foregoing disadvantages inherent in the known countertop kitchen appliance art, the present invention provides a novel kitchen food bar maker. The general purpose of the present invention, which will be described subsequently in greater detail is to provide a small, countertop kitchen appliance that presses various food ingredients in a mold to create a compressed meal bar.

The kitchen food bar maker can be manual or, preferably, electronic. In an electronic embodiment, the press is operated by a programmable computer and only requires a user to press a button to start the process. In a manual embodiment, the kitchen food bar maker has a press operated by a user pulling downward on a handle to press a plate into a mold frame to form a food bar. The press plate is the same size as the inner dimensions of the mold frame.

The kitchen food bar maker allows users to create meal bars at home from their own custom recipes. The meal bars can then be enjoyed at home, at work, on the road, or during outdoor activities. The bars can be made in any shape or size the mold and press plate can be formed in. Molds and press plates can also be formed to create two or more food bars at the same time. The press plate can also be formed to imprint a logo on each bar as the ingredients are compressed.

The present invention holds significant improvements and serves as a countertop kitchen food bar maker. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a countertop food bar maker, constructed and operative according to the teachings of the present invention.

FIG. 1 shows a perspective view illustrating an electric countertop food bar maker according to an embodiment of the present invention.

FIG. 2 is a perspective view illustrating an electric countertop food bar maker and mold, according to an embodiment of the present invention of FIG. 1.

FIG. 3 is a perspective view illustrating a manual countertop food bar maker and mold according to an embodiment of the present invention.

FIG. 4 is a perspective view illustrating a variety of food bars that can be manufactured according to the embodiments of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to a kitchen countertop appliance and more particularly to a kitchen countertop food bar maker.

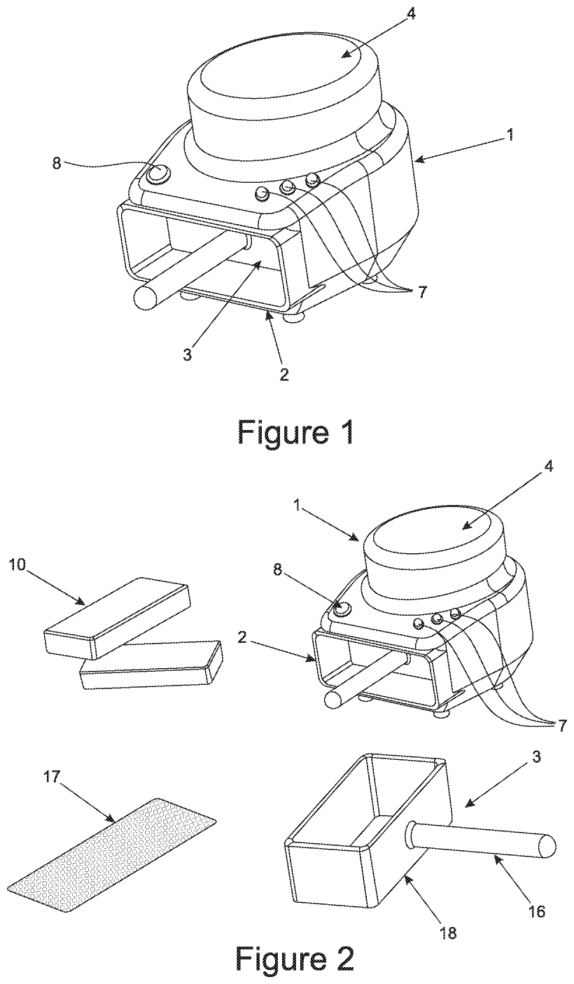

Referring to the drawings by numerals of reference there is shown in FIGS. 1 and 2, a kitchen countertop food bar maker including a main body 1 with an opening 2 in the front for the mold 3 to be inserted into the kitchen countertop food bar maker. The main body includes an outer press motor housing 4 that preferably contains an electronic press apparatus 5, such as a worm drive mechanism with a worm gear and a worm wheel, that is used to compress the food ingredients.

The electric press apparatus 5 includes a programmable device 6 that is pre-programmed with one or more different pressure force settings, such as 1-2-3 with 1 for light presses and 3 for higher pressure. Buttons 7 on the outside of the main body 1 can be pressed by the user to indicate the desired pressure force setting. Each button 7 transmits the signal to the programmable device 6, which alters the pressure force setting accordingly. The electric press apparatus 5 is turned on by a start button 8 on the outside of the main body 1 that likewise transmits a signal to the programmable device 6 to start the electric press apparatus 5.

The electric press apparatus 5 may alternately include a servomechanism press, also known as a servo press or electro press, to provide pressure that pushes material into a mold 3 to form food items 9 into an edible shaped bar 10. Power is provided by an AC servo motor 11 that turns a rod 12. Many mechanisms can be used to generate linear motion from a rotating motor. For example, the torque produced by the rotating rod 12 can be converted to a linear force via a ball screw 13. Pressure and position are controlled through a load cell 14 and an encoder 15.

In another embodiment, the electric press apparatus 5 may include a linear actuator 16 to produce press motion in a straight line.

The mold 3 generally has a bar shape, although any reasonably simple shape will also work, and includes a frame 18, a handle 16 located on the front side of the frame 18, and a removable base plate 17. The press plate 19 on the electric press apparatus 5 has the same dimensions as the inner dimensions of the mold frame 18, so that the press plate 19 fits snuggly inside the mold frame 18 to prevent leakage around the edges during compression.

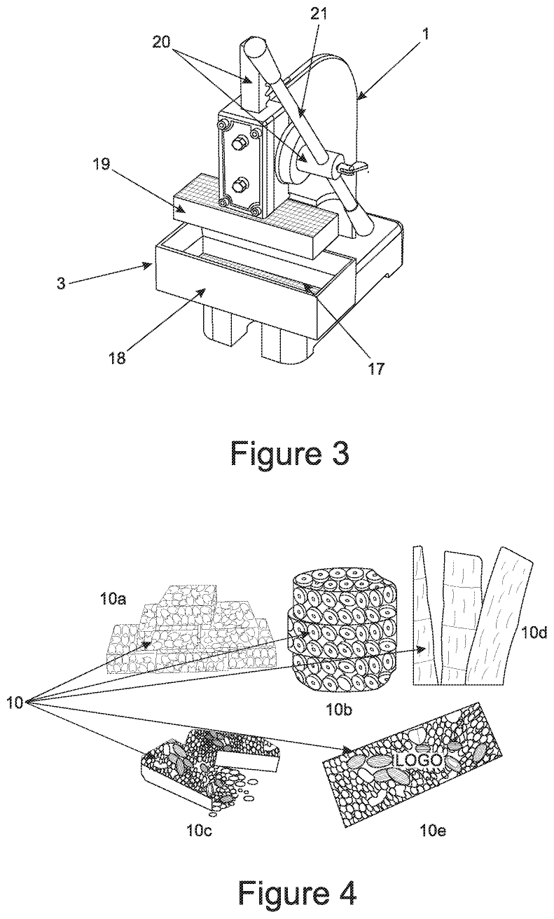

Referring now to FIG. 3, a kitchen countertop food bar maker including a main body 1 with the mold 3 in the front. The main body includes an outer press motor housing 4, which, in an alternate to the electronic press apparatus, contains a manual press apparatus 20, such as a worm screw mechanism, that is used to compress the food ingredients. The manual press apparatus 20 is operated by a handle 21 that the user rotates to raise and lower the press plate 19 into the mold 3. The manual press apparatus 20 transfers the rotation of the handle 21 into a vertical up and down movement. As in the electric embodiment, the press plate 19 has the same outer dimensions as the inner dimensions of the mold 3. Both the press plate 19 and mold 3 can be any reasonably simple shape, and are removable so it can be swapped out for another mold and press plate. The press plate 19 can also have a logo embossed on its surface to press a logo into the top of the food bar.

Referring now to FIG. 4, showing a few examples of molded food bars 10 that can be made with either of the above embodiments of the kitchen countertop food bar maker. These include bar shaped food bars 10a, round food bars 10b, heart shaped food bars 10c, dried jerky-like food bars 10d, and food bars with a logo pressed into the top 10e.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A kitchen countertop food bar maker device comprising:
(a) a main body;
(b) a removable mold with an inner dimension and an outer dimension including
(i) a mold frame,
wherein the mold frame defines the inner dimension and outer dimension of the mold; and
(ii) a removable base plate;
(c) a removable press plate with an outer dimension,
wherein the outer dimension of the press plate is essentially the same as the inner dimension of the mold so that the press plate delivers even pressure across an entire inner surface of the mold;
(d) a press apparatus,
wherein the press apparatus is operably connected to the press plate to produce a vertical up and down press motion in a straight line so that the press plate delivers even pressure across the entire inner surface of the mold,
wherein the press apparatus is housed within the main body, and
wherein the press apparatus is operated manually or electronically.

2. The kitchen countertop food bar maker device of claim 1, wherein the removable mold further comprises:
(iii) a mold handle.

3. The kitchen countertop food bar maker device of claim 1, wherein the press apparatus is an electric press apparatus.

4. The kitchen countertop food bar maker device of claim 1, wherein the press apparatus is a manual press apparatus.

5. The kitchen countertop food bar maker device of claim 3, wherein the electric press apparatus is selected from the group consisting of worm drive, a servomechanism press, and a linear actuator.

6. The kitchen countertop food bar maker device of claim 4, wherein the manual press apparatus is a worm drive.

7. The kitchen countertop food bar maker device of claim 3, wherein the kitchen countertop food bar maker device further comprises:
(e) a motor operably connected to run the press apparatus;
(f) a programmable device operably connected to control the motor;
(g) a start button,
wherein the start button is operably connected to the programmable device so that when pressed, the programmable device receives a signal to start the motor; and
(h) an opening operably located in a front portion of the main body so that a user can insert the mold into the main body and align the mold with the press plate.

8. The kitchen countertop food bar maker device of claim 7, wherein the kitchen countertop food bar maker device further comprises:
(i) one or more pressure setting buttons,
wherein the one or more pressure setting buttons are operably connected to the programmable device so that when pressed, the programmable device receives a signal indicating a desired pressure setting and uses the desired pressure setting to control the pressure applied by the press apparatus via the motor.

9. The kitchen countertop food bar maker device of claim 4, wherein the kitchen countertop food bar maker device further comprises:
(e) a handle,
wherein the handle is operably connected to control the manual press apparatus so that the manual press apparatus applies pressure to the mold via the press plate when a user pulls or rotates the handle.

10. The kitchen countertop food bar maker device of claim 3, wherein the press plate has a logo embossed on a bottom surface of the press plate.

11. The kitchen countertop food bar maker device of claim 4, wherein the press plate has a logo embossed on a bottom surface of the press plate.

12. The kitchen countertop food bar maker device of claim 1, wherein the mold and the press plate have a shape selected from the group consisting of a rectangle, a circle, a heart, a star, two rectangles, and an oval.
